(19) United States
(12) Patent Application Publication
(10) Pub. No.: US 2008/0032124 A1
(43) Pub. Date: Feb. 7, 2008

(54) Inorganically Coated Synthetic Body, Method for Producing the Same and Its Use

(75) Inventors: Patrick Becker, Muhltal (DE); Rolf Neeb, Muhltal (DE); Ghirmay Seyoum, Egelsbach (DE)

Correspondence Address: OBLON, SPIVAK, MCCLELLAND MAIER & NEUSTADT, P.C., 1940 DUKE STREET, ALEXANDRIA, VA, 22314, US

(73) Assignee: ROEHM GMBH, Darmstadt (DE)

(21) Appl. No.: 11/572,716

(22) PCT Filed: Jul. 9, 2005
(86) PCT No.: PCT/EP05/07469

§ 371 Date: Jan. 26, 2007

(30) Foreign Application Priority Data
Sep. 16, 2004 (DE) 10 2004 045 295.4

(51) Int. Cl. C08J 5/00; B29C 37/00; C08J 7/06; C09D 1/00

(52) U.S. Cl. 428/336; 427/230; 428/451

(57) ABSTRACT

The invention relates to a method for producing a synthetic body from a synthetic material obtained by radical polymerization, which is coated on one or several sides with an Si-containing or inorganic substance. According to the inventive method, a substrate is coated with a lacquer composition which contains inorganic particles dissolved in a solvent which may optionally also contain a flow-control agent. One or more substrates that are coated in this manner can be used to construct a polymerization chamber, the coated sides facing the interior of the chamber. After radical polymerization of a monomer mixture in the presence of a polymerization initiator and a separating agent mixture the inward inorganic coating is transferred from the substrate to or onto the surfaces of the radically polymerized synthetic material or the corresponding synthetic body. The invention also relates to the corresponding synthetic bodies and their uses and to the use of the separating agent mixture in the polymerization casting method.

The invention relates to plastics articles with inorganic coating, their use and processes for their production.

### PRIOR ART

EP-A 0 193 269 relates to substrates coated with silica particles. The coating has very uniform layer thickness, has exceptionally secure adhesion to the substrate and has good antireflective properties.

U.S. Pat. No. 4,571,361 describes antistatic plastics films. Here, films composed of, by way of example, cellulose acetate or polyethylene terephthalate are coated with polymerizable lacquer systems which may comprise, by way of example, antimony tin oxide particles. This gives films with abrasion-resistant coatings and with low surface resistances in the range smaller than or equal to 10⁷Ω.

EP-B 0 447 603 describes antistatic coating compositions comprising a silicate solution and a conductive solution. The two solutions are mixed for hydrolysis and for polycondensation to give the coating composition mentioned, which has a chemical bond between the silicate and the conductive material. The coating composition is suitable for producing antistatic, antiglare visual display screens from panels of glass or of plastic.

Addition of release agents to polymerizable liquids polymerized in the cell-polymerization process is known. U.S. Pat. No. 5,134,210 makes fairly general mention of a large number of suitable substances, dioctyl sulphosuccinate particular being said to give acceptable results.

### OBJECT AND ACHIEVEMENT OF OBJECT

It is known that substrates, e.g. glass or plastics articles, can be equipped with inorganic layers which by way of example, may have antistatic properties. These coatings are generally applied to the substrate surface by means of lacquer systems which can be cured via drying or polymerization. This gives coated substrates with fully satisfactory properties in relation to abrasion resistance and, by way of example, electrical conductivity.

An object was to provide a process which permits plastics articles to be equipped with inorganic coatings, the bonding achieved to the plastics surface being intended to be better than in the prior art. In particular, the inventive process is intended to be easy to work and to be applicable to production with minimum scrap.

This object is achieved by way of a

process for producing a plastics article from a plastic obtainable via free-radical polymerization with inorganic coating on one or more sides via the following process steps:

a) using doctoring, flow coating, or immersion to coat a substrate with a lacquer composition in which a silicon-based adhesion promoter and inorganic particles are present in a ratio of from 1:9 to 9:1 in a solvent which, where appropriate, may also comprise flow control agent,
b) drying the lacquer composition on the substrate, thus obtaining the coated substrate,
c) using one or more substrates thus coated to construct a polymerization cell, where the coated sides are in the interior of the cell,
d) charging a polymerizable liquid composed of monomers capable of free-radical polymerization, where appropriate with polymeric contents to the polymerization cell, where the polymerizable liquid comprises from 0.16 to 0.28% by weight of a release agent mixture composed of a C₆-C₂₀-alkyl sulphosuccinate and of a C₆-C₂₀-alkyl phosphate,
e) free-radical polymerization of the polymerizable liquid in the presence of a polymerization initiator, whereupon the internal inorganic coating transfers from the substrate into or onto the surfaces of the free-radical-polymerized plastic or of the plastics article, and
f) removing the coated plastics article with inorganic coating on one or more sides from the polymerization cell.

The inventive process can give plastics articles with improved properties in relation to the scrub resistance of the surface. Furthermore, it is possible to achieve very uniform layer thicknesses of the inorganic coatings and high uniformity of the surfaces. The plastics articles can moreover be removed easily from the polymerization cell, so that operation of the entire process can be non-critical and, even in the case of mass production, substantially free from disruption.

### DESCRIPTION OF THE INVENTION

The invention provides a

Process for producing a plastics article from a plastic obtainable via free-radical polymerization with inorganic coating on one or more sides.

A plastics articles means any plastics item which has practically any desired shape and is obtainable through the inventive process. By way of example, preferred plastics articles may have the shape of flat sheets. However, examples of other plastics articles are corrugated sheets, cubes, blocks, round rods, etc. The modulus of elasticity of the plastics article to ISO 527-2 may, by way of example, be at least 1500 MPa, preferably at least 2000 MPa. Examples of the thickness of the sheets range from 1 to 200 mm, in particular from 3 to 30 mm. Examples of usual dimensions for solid sheets are in the range from 3×500−2000×2000−6000 mm (thickness×width×length).

Depending on the application, the inorganic coating process may take place on one or more sides. In the case of flat sheets, one or both of the large surfaces will preferably be coated. However, it is also possible to coat the smaller edge surfaces or to undertake all-round coating of all of the surfaces.

The Process Encompasses at Least the Process Steps a) to f)

Process Step a):

Using doctoring, flow coating, or immersion to coat a substrate with a lacquer composition in which a silicon-based adhesion promoter and inorganic particles are present in a ratio of from 1:9 to 9:1 in a solvent which, where appropriate, may also comprise flow control agent.

A substrate means in the first instance an article of practically any desired type in relation to shape and material, as long as it is suitable for the purposes of the invention. In particular, the substrate has to be coatable and suitable for constructing a polymerization cell. Flat sheets composed of a hardy solid material, e.g. ceramic, metal or particularly preferably glass, are particularly suitable for this purpose. Sheets composed of plastic or plastic films can likewise be suitable. In particular, plastics films composed of polyethylene terephthalate can be suitable. In order to be suitable for the construction of a polymerization cell, films may have been applied, adhesive-bonded or absorbed onto a hard substrate, e.g. onto a glass sheet.

The substrate may be composed of a plastic. Among these are in particular polycarbonates, polystyrenes, polyesters, such as polyethylene terephthalate (PET), where these may also have been modified with glycol, and polybutylene terephthalate (PBT), cyclooefinic copolymers (COCs), acrylnitrile-butadine-styrene copolymers and/or poly(meth)acylates.

Preference is given here to polycarbonates, cyclooefinic polymers and poly(meth)acrylates, and particular preference is given here to poly(meth)acrylates.

Polycarbonates are known to persons skilled in the art. Polycarbonates may be formally regarded as polyesters derived from carbonic acid and from aliphatic or aromatic dihydroxy compounds. They are readily accessible via reaction of diglycols or bisphenols with phosgene or with carbonic diesters via polycondensation or transesterification reactions.

Preference is given here to polycarbonates which derive from bisphenols. Among these bisphenols are in particular 2,2-bis(4-hydroxyphenyl)propane (bisphenol A), 2,2-bis(4-hydroxyphenyl)butane (bisphenol B), 1,1-bis(4-hydroxyphenyl)cyclohexane (bisphenol C), 2,2′-methylenediphenol (bisphenol F), 2,2-bis(3,5-dibromo-1-hydroxyphenyl)propane (tetrabromobisphenol A) and 2,2-bis(3,5-dimethyl-4-hydroxyphenyl)propane (tetramethylbisphenol A).

Aromatic polycarbonates of this type are usually prepared via interfacial polycondensation or via transesterification, a detailed description being given in Encycl. Polym Sci. Engng. 11, 648-718.

In interfacial polycondensation, the bisphenols are emulsified in the form of an aqueous, alkaline solution in inert organic solvents, such as methylene chloride, chlorobenzene or tetrahydrofuran, and are reacted in stages with phosgene. Catalysts used comprise amines, or in the case of sterically hindered bisphenols also phase-transfer catalysts. The resultant polymers are soluble in the organic solvents used.

The properties of the polymers can be varied widely via the selection of the bisphenols. If simultaneous use is made of different bisphenols, it is also possible to build up block polymers in multistage polycondensation reactions.

Cycloolefinic polymers are polymers which are obtainable by using cyclic olefins, in particular polycyclic olefins.

Cyclic olefins encompass, for example monocyclic olefins, such as cyclopentene, cyclopentadiene, cyclohexene, cycloheptene, cyclooctene and also alkyl derivatives of these monocyclic olefins having from 1 to 3 carbon atoms, examples being methyl, ethyl or propyl, e.g. methylcyclohexene or dimethyloyclohexene, and also acrylate and/or methacrylate derivatives of these monocyclic compounds. Furthermore, cycloalkanes having olefinic side chains may also be used as cyclic olefins, an example being cyclopentyl methacrylate.

Preference is given to bridged polycyclic olefin compounds. These polycyclic olefin compounds may have the double bond either in the ring, in which case they are bridged polycyclic cycloalkenes, or else in side chains. In that case they are vinyl derivatives, allyloxycarboxy derivatives or (meth)acryloxy derivatives of polycyclic cycloalkane compounds. These compounds may also have alkyl, aryl or aralkyl substituents.

Without any intended resultant restriction, examples of polycyclic compounds are bicyclo[2.2.1]hept-2-ene (norbornene), bicyclo[2.2.1]hept-2,5-diene (2,5-norbornadiene), ethylbicyclo[2.2.1]hept-2-ene (ethylnorbornene), ethylidenebicyclo[2.2.1]hept-2-ene (ethylidene-2-norbornene), phenylbicyclo[2.2.1]hept-2-ene, bicyclo[4.3.0]nona-3,8-diene, tricyclo[4.3.0.1^{2,5}]-3-decene, tricyclo[4.3.0.1^{2,5}]-3,8-decene (3,8-dihydrodicyclopentadiene), tricyclo[4.4.0.1^{2,5}]-3-undecene, tetracyclo[4.4.0.1^{2,5}.1^{7,10}]-3-dodecene, ethylidenetetracyclo[4.4.0.1^{2,5}.1^{7,10}]-3-dodecene, methyloxycarbonyltetracyclo[4.4.0.1^{2,5}.1^{7,10}]-3-dodecene ethylidene-9-ethyltetracyclo[4.4.0.1^{2,5}.1^{7,10}]-3-dodecene, pentacyclo[4.7.0.1^{2,5}.0.0^{3,13}.1^{9,12}]-3-pentadecene, pentacyclo-[6.1.1^{3,6}.0^{2,7}.0^{9,13}]-4-pentadecene, hexacyclo-[6.6.1.1^{3,6}.1^{10,13}.0^{2,7}.0^{9,14}]-4-heptadecene, dimethylhexacyclo[6.6.1.1^{3,6}.1^{10,13}.0^{2,7}.0^{9,14}]-4-heptadecene, bis(allyloxycarboxy)tricyclo[4.3.0.1^{2,5}]decane, bis(methacryloxy)tricyclo[4.3.0.1^{2,5}]decane, bis(acryloxy)tricyclo[4.3.0.1²⁵]decane.

The cycloolefinic polymers are prepared using at least one of the cycloolefinic compounds described above, in particular the polycyclic hydrocarbon compounds. The preparation of the cycloolefinic polymers may, furthermore, use other olefins which can be copolymerized with the abovementioned cycloolefinic monomers Examples of these are ethylene, propylene, isoprene, butadiene, methylpentene, styrene, and vinyltoluene.

Most of the abovementioned olefins, and in particular the cycloolefins and polycycloolefins, may be obtained commercially. Many cyclic and polycyclic olefins are moreover obtainable by Diels-Alder addition reactions. The cycloolefinic polymers may be prepared in a known manner, as set out inter alia in the Japanese Patent Specifications 11818/1972, 43412/1983, 1442/1986 and 19761/1987 and in the published Japanese Patent Applications Nos. 75700/1975, 129434/180, 127728/1983, 163708/1985, 271308/1986, 221118/1988 and 180976/1990 and in the European Patent Applications EP-A-0 610 851, EP-A-0 485 893 EP-A-0 407 870 and EP-A-0 688 801.

The cycloolefinic polymers may, for example, be polymerized in a solvent, using aluminium compounds, vanadium compounds, tungsten compounds or boron compounds as catalyst.

It is assumed that, depending on the conditions in particular on the catalyst used, the polymerization can proceed with ring-opening or with opening of the double bond.

It is also possible to obtain cycloolefinic polymers by free-radical polymerization, using light or an initiator as free-radical generator. This applies in particular to the acryloyl derivatives of the cycloolefins and/or cycloalkanes. This type of polymerization may take place either in solution or else in bulk.

Another preferred plastics substrate encompasses poly(meth)acrylates. These polymers are generally obtained via free-radical polymerization of mixtures which comprise (meth)acrylates. These have been described above and, depending on production requirements, it is possible to use either monofunctional or polyfunctional (meth)acrylates.

According to one particular aspect of the present invention, these mixtures comprise at least 40% by weight, preferably at least 60% by weight and particularly preferably at least 80% by weight, based on the weight of the monomers, of methyl methacrylate.

Alongside the abovementioned (meth)acrylates, the compositions to be polymerized may also comprise other unsaturated monomers copolymerizable with methyl methacrylate and with the above-mentioned (meth)acrylates. Examples of these have in particular been set out under component E).

The amount generally used of these comonomers is from 0 to 60% by weight, preferably from 0 to 40% by weight and particularly preferably from 0 to 20% by weight, based on the weight of the monomers, and these compounds may be used individually or in the form of a mixture.

The polymerization is generally initiated using known free-radical initiators, in particular described under component D). The amount often used of these compounds is from 0.01 to 3% by weight, preferably from 0.05 to 1% by weight, based on the weight of the monomers.

The abovementioned monomers may be used individually or in the form of a mixture. Use may also be made here of various polycarbonates, poly(meth)acrylates or cycloolefinic polymers, differing in molecular weight or in monomer composition, for example.

The plastics substrates may also be produced by cell casting processes. In these, by way of example, suitable (meth)acrylic mixtures are charged to a mould and polymerized. These (meth acrylic mixtures generally comprise the (meth)acrylates set out above, in particular methyl methacrylate. The (meth)acrylic mixtures may moreover comprise the copolymers set out above, and also, in particular for viscosity adjustment, may comprise polymers, in particular poly(meth)acrylates.

The weight-average molar mass M_{w} of the polymers prepared by cell casting processes is generally higher than the molar mass of polymers used in moulding compositions. This gives a number of known advantages. With no resultant intended restriction, the weight-average molar mass of polymers prepared by cell casting processes is generally in the range from 500 000 to 10 000 000 g/mol.

Preferred plastics substrates prepared by the cell casting process may be obtained commercially with the trade name ®Acrylite from Cyro Inc. USA.

In so far as the substrates are composed of plastic, they may also comprise conventional additives of any type. Examples of these are antioxidants mould-release agents, flame retardants, lubricants, dyes flow improvers fillers, light stabilizers and oranophosphorus compounds, such as phosphoric esters, phosphoric diesters and phosphoric monoesters, phosphites, phosphorinanes, phospholanes or phosphonates, pigments, weathering stabilizers and plasticizers. However, the amount of additives is restricted in relation to the application.

Particularly preferred moulding compositions which encompass poly(meth)acrylates are obtainable with the trade name Acrylite® from the company Cyro Inc. USA. Preferred moulding compositions which encompass cycloolefinic polymers may be purchased with the trade name ®Topas from Ticona and ®Zeonex from Nippon Zeon. Polycarbonate moulding compositions are obtainable, by way of example, with the trade name ®Makrolon from Bayer or ®Lexan from General Electric.

The plastics substrate particularly preferably encompasses at least 80% by weight, in particular at least 90% by weight, based on the total weight of the substrate, of poly(meth)acrylates, polycarbonates and/or cycloolefinic polymers. The plastics substrates are particularly preferably composed of polymethyl methacrylate, and this polymethyl methacrylate may comprise conventional additives.

In one preferred embodiment, plastics substrates may have an impact strength to ISO 179/1 of at least 10 kJ/m², preferably at least 15 kJ/m².

The shape and the size of the plastics substrate are not important for the present invention. Substrates generally used often have the shape of a sheet or a panel, and have a thickness in the range from 1 mm to 200 mm, in particular from 5 to 30 mm.

The lacquer composition comprises an adhesion promoter and inorganic particles in a ratio of from 1:9 to 9:1 by weight.

The adhesion promoter may be composed of a colloidal solution of SiO₂ particles or of silane condensates. From 1 to 2% by weight of SiO₂ and from 2.5 to 7.5% by weight of other inorganic particles are preferably present in a solvent or solvent mixture, which, where appropriate, also comprises flow control agent and water. Examples of the concentration at which the flow control agent may be present are from 0.01 to 2% by weight, preferably from 0.1 to 1% by weight.

The amounts of other binders or polymerizing organic components present are preferably zero or, if non-zero, only very small and non-critical.

For the purposes of the present invention, the term inorganic means that the carbon content of the inorganic coating is not more than 25% by weight, preferably net more than 17% by weight, and very particularly preferably not mere than 10% by weight, based on the weight of the inorganic coating (a). This variable may be determined by means of elementary analysis.

According to another aspect of the present invention it is also possible to use silane condensates which comprise a colloidal solution of SiO₂ particles. Solutions of this type may be obtained by the sol-gel process in particular condensing tetraalkoxysilanes and/or tetrahalosilanes.

The abovementioned silane compounds are usually used to prepare aqueous coating compositions, by hydrolysing organosilicon compounds with an amount of water sufficient for the hydrolysis reaction, i.e. >0.5 mol of water per mole of the groups intended for hydrolysis e.g. alkoxy groups preferably with acid catalysis. Examples of acids which may be added are inorganic acids such as hydrochloric acid, sulphuric acid, phosphoric acid, nitric acid, etc., or organic acids such as carboxylic acids organic sulphuric acids etc., or acid ion exchangers the pH for the hydrolysis reaction usually being from 2 to 4.5 preferably 3.

The coating composition preferably comprises inorganic particles in the form of from 1 to 2% by weight, preferably from 1.2 to 1.8% by weight, SiO₂ and from 2.5 to 7.5% by weight, preferably from 3 to 7% by weight particularly preferably from 4 to 6% by weight, of antimony tin oxide particles, in water as solvent. The pH set is preferably alkaline in order that the particles do not agglomerate. The size of these oxide particles is non-critical but transparency is particle-size-dependent. The size of the particles is preferably not more than 300 nm, and in particular in the range from 1 to 200 nm, preferably from 1 to 50 nm.

According to one particular aspect or the present invention, the colloidal solution is preferably applied at a pH greater than or equal to 7.5, in particular greater than or equal to 8 and particularly greater than or equal to 9.

Basic colloidal solutions are less expensive than acidic solutions. Furthermore, basic colloidal solutions of oxide particles can be stored particularly easily and for a long period.

The abovementioned coating compositions may be obtained commercially with the trade name ®Ludox (Grace, Worms, Germany); ®Levasil (Bayer, Leverkusen, Germany); ®Klebosol (Clariant).

The flow control agent mentioned is also preferably present, e.g. at a concentration of from 0.1 to 1% by weight, preferably from 0.3 to 0.5% by weight, in order to promote good dispersion of the particles.

The lacquer composition may be mixed from individual components prior to use.

For example, use may be made of a commercially available antimony tin oxide solution or suspension in water of strengths from 10 to 15% (solution 1), which may be mixed with a ready-to-use silica sol solution (solution 2) and with a diluent solution (solution 3).

By way of example, the silica sol solution may initially, in concentrated form, comprise SiO₂ particles in the size range from 10 to 100 nm, preferably from 7 to 50 nm, and may take the form of an aqueous solution or, respectively, suspension which is alkaline and whose strength is from 20 to 30%. The concentrated solution may in turn be adjusted to about 30% strength in H₂O, to give a ready-to-use solution (solution 2). It is preferable to add a distribution aid or a flow control agent. Examples of suitable materials are surfactants, and addition of [fatty alcohol+3 ethylene oxide, Genapol X 80] is preferred.

Besides the flow control agent having anionic groups, the coating composition may encompass other flow control agents, e.g. non-ionic flow control agents. Among these, particular preference is given to ethoxylates, and use may in particular be made here of esters or else alcohols or phenols having ethoxy groups. Among these are nonylphenol ethoxylates.

The ethoxylates in particular encompass from 1 to 20, in particular from 2 to 8, ethoxy groups. The hydrophobic radical of the ethoxylated alcohols and esters preferably encompasses from 1 to 40, preferably from 4 to 22, carbon atoms, and use may be made here of either linear or branched alcohol and/or ester radicals.

By way of example, products of this type may be obtained commercially with the trade name ®Genapol X80.

The addition of non-ionic flow control agent is restricted to an amount which has no substantial adverse effect on the antistatic coating. Based on the total weight of the coating composition, from 0.01 to 4 by weight, in particular from 0.1 to 2% by weight, of one or more non-ionic flow control agents is generally added to the coating composition.

The diluent (solution 3) used may comprise deionized H₂O which has been adjusted to about pH 9.0 with NaOH. Advantageously, a flow control agent may be present here.

Flow control agents having at least one anionic group are known to persons skilled in the art, and these flow control agents generally contain carboxy, sulphonate and/or sulphate groups. These flow control agents preferably encompass at least one sulphonate group.

Flow control agents having at least one anionic group encompass anionic flow control agents and amphoteric flow control agents which, besides an anionic group, also encompass a catalytic group. Among these, preference is given to anionic flow control agents. In particular, the use of anionic flow control agents permits the production of formable plastics articles.

The flow control agents having at least one anionic group preferably encompass from 2 to 20, preferably from 2 to 10 carbon atoms, and the organic radical here may contain either aliphatic or aromatic groups. According to one particular aspect of the present invention, use is made of anionic flow control agents which encompass an alkyl or cycloalkyl radical having from 2 to 10 carbon atoms.

The flow control agents having at least one anionic group may contain other polar groups, such as carboxy, thiocarboxy or imino, carboxylic ester, carbonic ester, thiocarboxylic ester, dithiocarboxylic ester, thiocarbonic ester, dithiocarbonic ester and/or dithiocarbamide groups.

Particular preference is given to flow control agents of the formula (I) 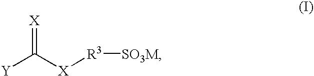
where X is independently an oxygen or sulphur atom, Y is a group of the formula OR², SR² or NR², where R² is, independently, an alkyl group having from 1 to 5, preferably from 1 to 3, carbon atoms, and R³ is an alkylene group having from 1 to 10, preferably from 2 to 4, carbon atoms, and M is a cation, in particular an alkali metal ion, in particular potassium or sodium, or an ammonium ion.

Based on the total weight of the coating composition, from 0.01 to 1% by weight, in particular from 0.03 to 0.1% by weight, of one or more flow control agents having at least one anionic group is generally added to the coating composition.

Compounds of this type may in particular be obtained from Raschig AG with the trade name Raschig OPX® or Raschig DPS®, and, by way of example, may be present at a concentration of from 0.1 to 1% by weight, preferably from 0.4 to 0.6% by weight.

In order to obtain a coating composition ready for use, it is preferable to begin by mixing solutions 2 and 3, for example in a ratio of from 1:1 to 1:2, e.g. 1:1.5, and then to mix the mixture with solution 1 in a ratio of about 1:1.

Process Step b)

Drying of the lacquer composition on the substrate to give the coated substrate.

After doctoring, flow coating or immersion has been used to coat a substrate, e.g. a glass sheet, the lacquer composition is dried. By way of example, this may take place in the temperature range from 50 to 200° C., preferably from 80 to 120° C., and it is necessary to adapt the temperature to the heat resistance of the substrate here A drying time of from 0.1 to 5 hours preferably from 2 to 4 hours, is generally sufficient to obtain an almost completely hardened coating. After the drying phase, a further standing phase may follow, e.g. from 12 to 24 hours at room temperature, in order to ensure complete hardening, prior to further use of the coated substrates.

Since the lacquer layer has been produced from a solution which has solids content of inorganic particles, the layer is composed of a continuous three-dimensional network of sphere-like structures and inevitably having a certain proportion of cavities. EP-A 0 193 259 discloses this structure.

Process Step c):

Use of one or more substrates coated in this way to construct a polymerization cell with coated sides in the interior of the cell.

One or more of the substrates coated in the preceding process step may then be used to construct a polymerization cell. A polymerization cell is a sealed-off space into which a liquid polymerizable mixture may be charged and within which this can be polymerized until a polymerized plastics article is obtained, which can be removed in solid form once the cell has been opened. Polymerization cells are well known, e.g. from the production of cast polymethyl methacrylate (see, for example, DE 25 44 245, EP-B 570 782 or EP-A 656 548).

If, by way of example, a glass sheet has been coated on one side via flow coating in the preceding process step, this may then be used with the coated side inward to construct a polymerization cell composed of two opposite glass sheets forming parallel planes at a distance from one another. The other, second glass sheet may in this case be a normal, uncoated sheet. Separation is ensured via appropriate edgings, or a frame. Particular polymerization cells known from the production of cast polymethyl methacrylate are composed of two glass sheets with a peripheral elastic sealing bead. The elasticity of the bead serves to compensate for shrinkage during the polymerization process. The cell is held together via appropriate clamps. There are apertures for charging and for air removal.

Process Step d):

Charging the polymerization cell with polymerizable liquid composed of monomers capable of free-radical polymerization where appropriate with polymeric content, where the polymerizable liquid comprises from 0.1 to 0.28% by weight of a release agent mixture composed of a C₆-C₂₀-alkyl sulphosuccinate and of a C₆-C₂₀-alkyl phosphate.

A polymerizable liquid composed of monomers capable of free-radical polymerization, where appropriate with polymeric content, is then charged to the polymerization cell. In principle, any of the liquids or, respectively, monomers or mixtures of monomers and polymers capable of polymerization in the cell process is suitable. The polymerizable liquid may comprise other soluble or insoluble additives, e.g. pigments, fillers, LTV absorbers. Examples of other materials which may be present are impact modifiers or light-scattering particles composed of plastics particles which have a multishell structure and/or have been crosslinked.

Examples of monomers capable of free-radical polymerization are monomers having one or more vinylic groups, e.g. methyl methacrylate, other esters of methacrylic acid, e.g. ethyl methacrylate, butyl methacrylate, hexyl methacrylate, cyclohexyl methacrylate, esters of acrylic acid e.g. methyl acrylate, ethyl acrylate, butyl acrylate, hexyl acrylate, cyclohexyl acrylate, or styrene and styrene derivatives, such as α-methylstyrene or p-methylstyrene Crosslinking monomers, such as triallyl cyanurate, allyl methacrylate or di(meth)acrylates, may likewise be present, but preferably only in relatively small amounts, e.g. from 0.1 to 2% by weight.

The material may be a homogeneous solution, e.g. composed of 100% of methyl methacrylate, or may be a monomer mixture, e.g. predominantly, from 80 to 99% by weight, methyl methacrylate and from 1 to 20% by weight of other copolymerizable monomers, e.g. methyl acrylate. The solution or the monomer mixture may have polymeric content, and by way of example the mixture charged may be composed of from 70 to 95% by weight of methyl methacrylate and 5 to 30% by weight of polymethyl methacrylate.

Release Agent Mixture

One important aspect of the invention is that the plastics articles produced in the polymerization cell can be released efficiently from the previously coated substrates, whereupon the electrically conductive coating transfers to the plastics articles. In particular, the plastics articles are intended to have no haze or cracks. During the polymerization process, there is to be no separation from the walls of the polymerization cell, with associated distortion. When the coated plastics articles are removed, no damage is to occur to the previously coated substrate. Because the coated substrates used preferably comprise glass plates, glass breakage is to be avoided during the removal of the plastics articles. For this reason, according to the claims a defined release agent mixture is added to the polymerizable liquid. This measure in particular contributes to a production process substantially free from disruption with high throughput rates and with a very low scrap level.

The polymerizable liquid comprises from 0.16 to 0.28% by weight, preferably from 0.18 to 0.25% by weight, of a release agent mixture composed of a C₆-C₂₀-alkyl sulphosuccinate, preferably a C₈-C₁₀-alkyl sulphosuccinate, and of a C₆-C₂₀-alkyl phosphate, preferably a C₈-C₁₀-alkyl phosphate.

The term C₆-C₂₀-alkyl sulphosuccinate and C₆-C₂₀-alkyl phosphate includes mixtures of the two classes of substance mentioned.

The total proportion of the C₆-C₂₀-alkyl sulphosuccinate is preferably not more than 0.1% by weight, particularly preferably from 0.02 to 0.08% by weight. The total proportion of the C₆-C₂₀-alkyl phosphate is preferably not more than 0.2% by weight, particularly preferably from 0.12 to 0.18% by weight. An example of a suitable C₆-C₂₀-alkyl sulphosuccinate is diisooctyl sulphosuccinate, which may, if appropriate be present in the form of sodium salt:sodium diisooctyl sulphosuccinate.

An example of a suitable C₆-C₂₀-alkyl phosphate is (mono)nonyl phosphate or dinonyl phosphate. Particular preference is given to a mixture composed of (mono)nonyl phosphate or dinonyl phosphate. The proportions of the (mono)nonyl phosphate and of the dinonyl phosphate in the mixture may, by way of example, be from 9.1 to 1:9 preferably from 5:4 to 4:6.

Accordingly, a release agent mixture composed of a C₆-C₂₀-alkyl sulphosuccinate and of a C₆-C₂₀-alkyl phosphate in a polymerizable liquid composed of monomers capable of free-radical polymerization, if appropriate with polymeric content, can be used advantageously for the purposes of improving the separation of a plastics article produced by the casting process from the polymerization cell. The use of the release agent mixture in the sense described is therefore not restricted to the inventive process, although it can be used with particular advantage therein.

Process Step e)

Free-radical polymerization of the polymerizable liquid in the presence of a polymerization initiator, whereupon the internal inorganic coating transfers from the substrate into or onto the surfaces of the free-radical-polymerized plastic or of the plastics article.

Prior to charging of the material to the polymerization cell, a polymerization initiator is preferably added, with uniform distribution, to the polymerizable solution or to the mixture composed of monomers capable of free-radical polymerization, where appropriate with polymeric content. The polymerizable liquid may then be polymerized to give the plastic, e.g. at from 40 to 80° C.

Examples which may be mentioned of polymerization initiators are: azo compounds, 2,2′-azobis(isobutyronitrile) or 2,2′-azobis(2,4-dimethylvaleronitrile), redox systems, such as the combination of tertiary amines with peroxides, and preferred examples are peroxides (cf. in this connection, by way of example, H. Rauch-Puntigam, Th. Völker, “Acryl-und Methacrylverbindungen” [Acrylic and methacrylic compounds], Springer, Heidelberg, 1967 or Kirk-Othmer, Encyclopedia of Chemical Technology, Vol. 1, pp. 386 et seq., J. Wiley, New York, 1978). Examples of suitable peroxide polymerization initiators are dilauroyl peroxide, tert-butyl peroctoate, tert-butyl periosononanoate, dicyclohexyl peroxydicarbonate, dibenzoyl peroxide or 2,2-bis(tert-butylperoxy)butane. Another preferred method carries out the polymerization using a mixture of various polymerization initiators of different half-life time, e.g. dilauroyl peroxide and 2,2-bis(tert-butylperoxy)butane, in order that during the course of polymerization, or else at various polymerization temperatures, the flow of free radicals is kept constant. The amounts used of polymerization initiator are generally from 0.01 to 2% by weight, based on the monomer mixture.

The arrangement usually used for the cells when conducting the polymerization ensures temperature control or heat dissipation, and, by way of example, the cells—which may lie horizontally in racks—may be held under polymerization conditions in hot-air ovens with high air velocity, in autoclaves using water spray, or in water-filled pans. The system is heated to start the polymerization. Controlled cooling is needed in order to dissipate the considerable heat of polymerization, specifically in the gelling region. The polymerization temperatures are usually from 15 to 70° C. at atmospheric pressure. In the autoclave they are advantageously from about 90 to 100° C. The residence time for the polymerization cell in the temperature-controlled medium varies, depending on the nature of the polymerization mixture and on the method, from a few hours to two or more days.

Examples of other additives which may be added, besides the polymerization initiator, are molecular-weight regulators, e.g. dodecyl mercaptane.

However, it is preferably to carry out the polymerization without molecular-weight regulators, in order to obtain high molecular weights.

In order to maximize conversion (>99% of polymer), the temperature should again be raised for a short period towards the end of the polymerization procedure, for example to above 100° C., e.g. to 120° C. It is advantageous to cool the mixture slowly, whereupon the polymer sheets become released from the mould sheets and can be removed.

When the monomer liquid is charged to the polymerization cell, it penetrates into the cavities of the coating of the substrate. By way of example, SiO₂ and antimony tin oxide may be present in the form of an interpenetrating network. During the polymerization, therefore, there is some degree of penetration of the inorganic layer by the resultant polymer of the plastic article. The result is therefore a coating structure which differs structurally from the subsequently applied coatings known from the prior art.

“Annealing” may also take place, where appropriate, by permitting the plastics articles to age after the polymerization reaction, preferably while still within the polmerization cell, and heating them again, e.g. for from 2 to 8 hours, to from 40 to 120° C., after the cooling process. This permits escape of residual monomer and reduction of internal stresses within the plastics article.

Process Step f):

Removal from the polymerization cell of the coated plastics article with inorganic coating on one or more sides.

Once the polymerization cell has been dismantled or opened, the plastics article with inorganic coating on one or more sides may be removed. It is preferable to produce a polymethyl methacrylate sheet with an electrically conductive coating on one or more sides.

Plastics Articles

The plastics article obtainable by the inventive process preferably has an electrically conductive coating whose surface resistance is smaller than or equal to 10¹⁰Ω, preferably smaller than or equal to 10⁷Ω, and comprises from 0.16 to 0.28% by weight, preferably from 0.18 to 0.25% by weight, of a release agent mixture composed of a C₆-C₂₀-alkyl sulphosuccinate, preferably a C₈-C₁₀-alkyl sulphosuccinate, and of a C₆-C₂₀alkyl phosphate, preferably a C₈-C₁₀-alkyl phosphate.

No Tyndall effect indicating haze is discernible. Rainbow interference effects, which are evidence of non-uniform layer distribution are almost or entirely absent on the coated surfaces. By way of example, the surface resistance of the coating may be determined to DIN EN 613402/IEC 61340, using a Wolfgang Warmbier SRM-110 ohmmeter.

The plastics article is preferably composed of a polymethyl methacrylate, i.e. of a polymer predominantly composed of methyl methacrylate, or of a polystyrene. The plastic may comprise added materials and auxiliaries such as impact modifiers pigments, fillers, UV absorbers, etc. The plastics article may also be translucent or transparent.

The layer thickness of the electrically conductive coating is in the range from 200 to 5000 nm, preferably from 250 to 1000 nm, particularly preferably in the range from 300 to 400 nm.

The inorganically coated surface of the plastics article has a scrub resistance to DIN 53 778 of at least 10 000 cycles, preferably at least 12 000 cycles, in particular at least 15 000 cycles. By way of example, a M 105/A wet-scrub tester from Gardner may be used to determine the adhesion of the coating in the wet-scrub test to DIN 53 7708 Examples of the use of the plastics article are use for encasing structures for equipping cleanrooms for machine covers, for incubators, for displays, for visual display screens and visual-display-screen covers, for rear-projection screens, for medical apparatus and for electrical devices.

### ADVANTAGEOUS EFFECTS OF THE INVENTION

The inventive process permits the production of plastics articles with a coating structure which differs structurally from the subsequently applied coatings known from the prior art.

The coating transferred from the coated substrate to the polymeric plastics article during its polymerization is of high quality. No Tyndall effect indicating haze is discernible Rainbow interference effects, which are evidence of non-uniform layer distribution are almost or entirely absent on the coated surfaces. Abrasion resistance is higher than that of conventionally coated plastics articles. The plastics articles can be removed easily from the polymerization cell, and the operation of the entire process can therefore be non-critical and, even in cases of mass production, substantially free from disruption.

### EXAMPLES

### Inventive Example 1

Using a ratio of 1:1.5, 25 parts by weight of an anionic silica sol (solids content 30%; ®Levasil obtainable from Bayer AG) were mixed with 0.4 part by weight, made up to 100 parts by weight with deionized water, of an ethoxylated fatty alcohol (Genapol X80, and with a solution, made up to 100 parts by weight using aqueous NaOH solution at a pH of 9, of 0.5 part by weight of the potassium salt of 3-sulphopropyl O-ethyl dithiocarbonic acid (®Raschig OPX obtainable from Raschig AG).

50 parts by weight of this first solution were mixed with 50 parts by weight of an antimony tin oxide solution (12% strength in water; obtainable from Leuchtstoffwerk Breitungen GmbH).

The resultant coating composition was then applied to a glass pane by the flow-coating process and dried at 100° C. for 3 h. The coated glass panes were used to construct a polymerization cell having a peripheral bead.

A polymerizable solution composed of methyl methacrylate and comprising 0.1% by weight of a polymerization initiator (2,2′-azobis-(2,4-dimethylvaleronitrile)), and also comprising a release agent mixture composed of 0.05% by weight of diisooctyl succinate and 0.15% by weight of a mixture composed of monononyl phosphate and dinonyl phosphate is charged to the polymerization cell. The cell is incubated for 3 hours in a water bath at 50° C., and then the clamp-fixing system is removed, and the material is then annealed in a drying cabinet at 115° C. for 3.5 h. During the polymerization of the methyl methacrylate, the coating is transferred from the glass plates to the polymethyl methacrylate (PMMA) surface. The coated polymethyl methacrylate sheet is easy to separate from the glass panes, can be removed from the cell without glass breakage or break-away of the polymethyl methacrylate at the margin, and has good optical properties without haze or streaks.

The thickness of the extremely thin layers may be determined by transmission electron microscopy on a thin section. Depending on the direction of flow, the thickness of the layer was in the range from 350 to 400 nm.

The wet-scrub test to DIN 53778, using a M 105/A wet-scrub tester from Gardner, was used to determine the adhesion of the coating. The value determined was 20 000 cycles at a total layer thickness of 350 nm.

The surface resistance of the coating was determined to DIN EN 613402/E-61340, using a Wolfgang Warmbier SRM-110 ohmmeter. The value determined was 10⁶Ω at a total layer thickness of 350 nm.

The sheet exhibited good optical properties.

### Comparative Example 1

Inventive Example 1 was in essence repeated, but the coating composition was applied directly to the PMMA sheet by means of flow coating. The resultant coated sheet was then dried at 80° C. for 30 min.

The adhesion of the coating proved to be non-permanent, and it could be released from the PMMA sheet by repeated rubbing with a conventional wiper cloth.

### Comparative Example 2

Comparative Example 1 was in essence repeated, but the PMMA sheet was first provided with an adhesion-promoting layer (PLEX 9008L, obtainable from Röhm GmbH & Co. KG), and the coating composition was then applied by the flow coating process. The resultant coated sheet was then dried at 80° C. for 30 min.

The adhesion of the coating proved to be non-permanent and it could be released from the PMMA sheet by repeated rubbing with a conventional wiper cloth.

### Comparative Example 3

Inventive Example 1 is in essence repeated, but the formulation of the coating composition is changed so that the antimony tin oxide solution (12% strength in water; obtainable from Leuchtstoffwerk Breitungen GmbH) is applied directly to the glass sheet. It is impossible here to obtain uniform flow of the coating.

The transfer of the coating to the PMMA sheet is non-uniform. Some strong interference effects in the form of rainbow colours appear, indicating variations in the layer thicknesses of the coating.

### Comparative Example 4

Inventive Example 1 was in essence repeated, but the formulation of the coating composition was changed so that 95 parts by weight of the first solution and 5 parts by weight of the antimony tin oxide solution (12% strength in water; obtainable from Leuchtstoffwerk Breitungen GmbH) are used.

After transfer of the coating to the PMMA sheets, the coated sheets exhibit haze (Tyndall effect). The surface resistance is >10⁹Ω.

### Comparative Examples 5-16

Inventive Example 1 was repeated, but with different release agents or with different contents of release agent. The results are given in the table below. Unsatisfactory results were obtained from diisooctyl succinate alone (Ex. 5-10), mono- and dinonyl phosphate alone (Ex. 1), other release agents (Ex. 12-151, or an excessively low content of mono- and dinonyl phosphate in the release agent mixture (Ex. 16). Inventive Example 1 is restated in the final row for comparison.

| | | Proportion | | |
|---|---|---|---|---|
| Ex. | Release agent | [% by weight] | Polymerization/annealing | Result |
| 5 | Diisooctyl succinate, | 0.01 | The cell was polymerized at 50° C. | Difficult to separate, Plexiglas |
| | Na salt | | for about 3 h in a water bath. The | fracture, surface resistance < 10⁶ Ω |
| | | | material was then annealed in a | |
| | | | drying cabinet for 3.5 h at 115° C. | |
| 6 | Diisooctyl succinate, | 0.05 | The cell was polymerized at 50° C. | Difficult to separate, Plexiglas |
| | Na salt | | for about 3 h in a water bath. The | fracture, surface resistance < 10⁶ Ω |
| | | | material was then annealed in a | |
| | | | drying cabinet for 3.5 h at 115° C. | |
| 7 | Diisooctyl succinate, | 0.1 | The cell was polymerized at 45° C. | PMMA fracture at one corner, |
| | Na salt | | for about 6 h in a water bath. The | surface resistance < 10⁷ Ω, sheet |
| | | | material was then annealed in a | hazy |
| | | | drying cabinet for 3.5 h at 115° C. | |
| 8 | Diisooctyl succinate, | 0.1 | The cell was polymerized at 45° C. | With separation starting at 57° C., |
| | Na salt | | for about 6 h in a water bath. The | no adhesion but Plexiglas fracture |
| | | | material was then annealed in a | prior to start of separation + sheet |
| | | | drying cabinet for 3.5 h at 115° C. | hazy; surface resistance |
| | | | | < 10⁷ Ω |
| 9 | Diisooctyl succinate, | 0.1 | The cell was polymerized at 50° C. | Parts of the surface exhibit marked |
| | Na salt | | for 3 h in a water bath. The | haze when compared with a standard |
| | | | material was then annealed in a | PMMA sheet. Surface structures |
| | | | drying cabinet for 3.5 h at 115° C. | possibly caused by adhesion are |
| | | | | also discernible; surface |
| | | | | resistance < 10⁷ Ω |
| 10 | Diisooctyl succinate, | 0.2 | The cell was polymerized at 50° C. | The surface exhibits marked haze |
| | Na salt | | for 3 h in a water bath. The | (white deposit on the sheet). |
| | | | material was then annealed in a | Surface structures possibly caused |
| | | | drying cabinet for 3.5 h at 115° C. | by adhesion are also discernible; |
| | | | | surface resistance < 10⁷ Ω |
| 11 | Commercially | 0.2 | The cell was polymerized at 50° C. | Plexiglas fracture, slight adhesion |
| | available mixture | | for 3 h in a water bath. The | to mould glass, surface resistance < |
| | composed of mono- and | | material was then annealed in a | 10⁶ Ω |
| | dinonyl phosphate | | drying cabinet for 3.5 h at 115° C. | |
| 12 | Di-2-ethylhexyl | 0.1 | The cell was polymerized at 50° C. | Parts of the surface exhibit marked |
| | phosphate | | for 3 h in a water bath. The | haze when compared with a standard |
| | | | material was then annealed in a | PMMA sheet. Surface structures |
| | | | drying cabinet for 3.5 h at 115° C. | possibly caused by adhesion are |
| | | | | also discernible; surface |
| | | | | resistance < 10⁷ Ω |
| 13 | Di-2-ethylhexyl | 0.2 | The cell was polymerized at 50° C. | The surface exhibits marked haze |
| | phosphate | | for 3 h in a water bath. The | when compared with a standard PMMA |
| | | | material was then annealed in a | sheet; surface resistance < 10⁷ Ω |
| | | | drying cabinet for 3.5 h at 115° C. | |
| 14 | Stearic acid | 0.1 | The cell was polymerized at 50° C. | Non-uniform interference-lines |
| | | | for 3 h in a water bath. The | effect, PMMA fracture, poor |
| | | | material was then annealed in a | solubility of stearic acid in |
| | | | drying cabinet for 3.5 h at 115° C. | syrup; surface resistance < 10⁶ Ω |
| 15 | Stearic acid | 0.2 | — | Insoluble in mixture |
| 16 | Diisooctyl succinate, | 0.05 + 0.10 | The cell was polymerized at 50° C. | Easy to separate, Plexiglas |
| | Na salt + commercially | | for 3 h in a water bath. The | fracture at the margin, surface |
| | available mixture | | material was then annealed in a | resistance < 10⁷ Ω |
| | composed of mono- and | | drying cabinet for 3.5 h at 115° C. | |
| | dinonyl phosphate | | | |
| 1 | Diisooctyl succinate, | 0.05 + 0.15 | The cell was polymerized at 50° C. | Easy to separate, very good optical |
| | Na salt + commercially | | for 3 h in a water bath. The | properties; no Plexiglas fracture, |
| | available mixture | | material was then annealed in a | surface resistance: < 10⁶ Ω |
| | composed of mono- and | | drying cabinet for 3.5 h at 115° C. | |
| | dinonyl phosphate | | | |

1: Process for producing a plastics article from a plastic obtainable via tree-radical polymerization with inorganic coating on one or more sides via the following process steps:
a) using doctoring, flow coating, or immersion to coat a substrate with a lacquer composition in which a silicon-based adhesion promoter and inorganic particles are present in a ratio of form 1:9 to 9:1 in a solvent which, where appropriate, may also comprise flow control agent,
b) drying the lacquer composition on the substrate, thus obtaining the coated substrate,
c) using one or more substrates thus coated to construct a polymerization cell, where the coated sides are in the interior of the cell.
d) charging a polymerizable liquid composed of monomers capable of free-radical polymerization, where appropriate with polymeric content, to the polymerization cell, where the polymerizable liquid comprises from 0.16 to 0.28 by weight of a release agent mixture composed of a C₆-C₂₀-alkyl sulphosuccinate and of a C₆-C₂₀-alkyl phosphate,
e) free-radical polymerization of the polymerizable liquid in the presence of a polymerization initiator, whereupon the internal inorganic coating transfers from the substrate into or onto the free-radical-polymerized plastic or of the plastics article, and
f) removing the coated plastics article with inorganic coating on one or more side from the polymerization cell.

2: Process according to claim 1, wherein the plastics article has the shape of flat sheet.

3: Process according to claim 1, wherein the plastic obtainable via free-radical polymerization is a polymethyl methacrylate or a polystyrene.

4: Process according to claim 1, wherein the adhesion promoter is composed of a colloidal solution of SiO₂ particles or of silane condensates.

5: Process according to claim 1, wherein the lacquer composition comprises from to 2% by weight of SiO₂ particles and from 2.5 to 7.5% by weight of antimony tin oxide particles in water as solvent.

6: Process according to claim 5, wherein the lacquer composition also comprises a surfactant or a mixture of surfactants as flow control agent.

7: Process according to claim 1, wherein the substrate to be coated is a glass sheet, a plastics sheet, or a plastics film.

8: Process according to claim 7, wherein the plastics sheet or plastics film is composed of polyethylene terephthalate.

9: Process according to claim 1, wherein the substrate is dried with the lacquer composition at a temperature in the range from 80 to 120° C.

10: Process according to claim 1, wherein the polymerizable liquid is polymerized a from 40 to 80° C.

11: Process according to claim 1, wherein use is made of a polymerization cell in essence consisting of two sheets with peripheral sealing bead.

12: Process according to claim 1, wherein a sheet of polymethyl methacrylate plastic is produced with an electrically conductive coating on one or two sides.

13: Process according to claim 1, wherein the polymerizable liquid in process step d) comprises a release agent mixture composed of Na diisooctyl sulphosuccinate and of a mixture composed of monononyl and dinonyl phosphate.

14: Plastics articles obtainable by a process according to claim 1.

15: Plastics article according to claim 14, wherein the article has an electrically conductive coating with a surface resistance smaller than or equal to 10¹⁰Ω and comprises from 0.16 to 0.28% by weight of a release agent mixture composed of a C₆-C₂₀-alkyl sulphosuccinate and of a C₆-C₂₀-alkyl phosphate.

16: Plastics according to claim 14, wherein the layer thickness of the electrically conductive coatings is in the range from 200 to 5000 nm.

17: Plastics article according to claim 14, wherein the scrub resistance of the inorganically coated surface to DIN 53 778 is at least 10 000 cycles.

18: A method for encasing structures or for equipping cleanrooms, comprising incorporating the plastics article according to claim 14.

19: A method for improving the separation of a plastics article from the polymerization cell according to the process of claim 1 comprising adding a release agent mixture to the polymerizable liquid composed of monomers capable of free-radical polymerization and optionally with polymeric content wherein the release agent mixture is composed of a C₆-C₂₀-alkyl sulphosuccinate and of a C₆-C₂₀-alkyl phosphate.

20: A method for producing a plastics object having at least one exterior surface with an inorganic coating comprising constructing said plastics object having at least one exterior surface with an inorganic coating with the plastics article according to claim 14, wherein the plastics object having at least one exterior surface with an inorganic coating is selected from the group consisting of a machine cover, an incubator, a display, a visual display screen, a visual display screen cover, a rear projection screen, a medical apparatus and an electrical device.
